(19) United States
(12) Patent Application Publication
(10) Pub. No.: US 2002/0026457 A1
(43) Pub. Date: Feb. 28, 2002

(54) Method and system for interactive distribution of messages

(76) Inventor: Peter Albert Jensen, Oslo (NO)

Correspondence Address: BIRCH STEWART KOLASCH & BIRCH, PO BOX 747, FALLS CHURCH, VA, 22040-0747, US

(21) Appl. No.: 09/886,388

(22) Filed: Jun. 22, 2001

Related U.S. Application Data
(63) Continuation of application No. PCT/NO99/00401, filed on Dec. 21, 1999.

(30) Foreign Application Priority Data
Dec. 23, 1998 (NO) 1998 6118

(51) Int. Cl. G06F 17/00

(52) U.S. Cl. 707/501.1; 707/514

(57) ABSTRACT

A method and a communication system for interactive distribution of information such as advertising over a computer network is described. The system includes a first computer, an information server, containing the information to be distributed, and any number of second computers arranged to display said information as well as transmitting information such as requests for further information back to the information server. All the computers are preferably connected to the same computer network. The information in the Information server is arranged according to an information tree structure, such that when a first message is displayed on the information client, the user will be able to choose from a number of requests for further information, and when these further messages are presented, the user is again given such a choice, thus creating a dialogue involving the user. In a particular embodiment of the system, the messages are multimedia messages such as images, animated computer graphics and sound. In a preferred embodiment of this multimedia version, the text message from the information server is sent through a text to speech converter which converts the text to a string of phonemes, diphones or some other representation of speech and forwards this to the information client which in this particular embodiment includes a speech synthesizer and possibly a computer graphics program generating a “talking head”.

### FIELD OF THE INVENTION

The present invention relates to a method and a system for interactive distribution of messages from information providers to users over a computer network.

### BACKGROUND OF THE INVENTION

As a result of the enormous growth of the Internet and other computer networks, the market for distribution of information such as advertisement and information from information providers to users has been growing steadily. However, the possibilities native to computer systems regarding information handling has not been effectively exploited. Most advertising on computer networks is in the form of information banners or similar items on a web page, or as complete web pages. Through so called Common Gateway Interface (CGI) scripts and other programming, one out of a number of messages to be displayed can be selected based on information available through the communication protocols being used, such as the users geographic location. On some web pages, such as search engines, the message to be displayed is sometimes selected based on the search request entered by the user.

U.S. Pat. No. 5,848,396 describes a method and an apparatus for determining behavioral profile of a computer user. The method makes it possible to present advertisements according to a so called psychographic profile. The method further makes it possible to register and prepare statistics regarding which messages have been presented to users. However, while the method makes it possible to register whether a given user has responded to a given advertisement, it is not possible to allow the user to interact with the system by requesting a sequence of messages that constitutes a path through a set of messages ordered in an information tree structure, and to measure the relative interest of users by measuring the how far and down which path of the information tree the user progresses.

U.S. Pat. No. 5,794,210 describes a system for payment to computer and other users for paying attention to an advertisement or other “negatively priced” information distributed over a computer network. This system presents information that is detached from the content the user is seeking out on the network, and instead targets users based on digitally stored demographic profiles of potential users. The consumer database containing the profiles is created when the consumer, through his computer, registers for receiving ads, information and services. The system allows for competing advertisers to “bid” for the attention of users.

European patent application EP-A-847 156 describes a system for delivering music on demand over the Internet. The system maintains a subscriber profile database specifying demographic data. When a user requests a unit of music from the system, an advertising message is appended to the requested music based upon a matching of profile criteria.

International patent application WO 97/26729 describes a way of targeting ads by defining “communities” to which different users belong. Each community consists of people that have shown a tendency for similar interests and likes and dislikes, particularly people that have shown a tendency to be interested in the same ads. A measure of similarity is generated through tracking consumers' activities by means of “cookies”, or by software running on consumers' computers, such as in-line plug-ins, screensavers working in conjunction with a Web browser, or the Web browser itself.

### SUMMARY OF THE INVENTION

Through different systems for establishment of user profiles, advertisers are given the opportunity to target their advertising more efficiently. The present invention gives advertisers additional opportunities to keep users attention for a prolonged period of time, measure the attention paid to their ads by the users and to change their marketing strategy in real time based on such measurements.

The present invention is based on a an arrangement of information in an information server according to information tree structures. An information message is preferably selected for being displayed to a user based on the demographics defined by the advertiser as his or her intended audience. If a user's profile indicates that the user belongs to the targeted audience, the message is transferred to the users computer and displayed. When the message in displayed, the user will be presented with a number of choices, including requests for further information about the content of the message, related content etc., and an indication that the user is not interested in this message. If the user requests further information, he or she is presented with a new message and new choices. In this way the user can work his way through the information tree all the way to the last branch, or he can, at any point, break off by indication that he is not interested in further messages regarding this particular content. The information server will maintain a record of all these request, and preferably generate statistics indicating the success of the individual messages.

In accordance with a first aspect of the present invention, the selection of the particular message to be displayed when a user connects to the system is based on how much an advertiser is willing to pay for the display of the message. All advertisers using the system according to the present invention will have access either through their own computers or by contacting the system's operator, and by bidding they can make sure that their messages will be first in line for display to a given demographic group. In this way an advertiser can define several demographic groups to which he wants his message displayed, but he can give different priority to different groups.

In accordance with a second aspect of the present invention, statistics are generated showing how often a particular message has been displayed and in the case of a message targeted to several demographic groups as defined by the users' profiles how often the message has been displayed to each group. Further statistics are generated showing how far into the information tree users from different demographic groups have penetrated. Based on this information, an advertiser is given the opportunity to decide that he will no longer target a group that shows little or no interest in his messages, and instead he can shift the allocated resources from one group to another. Allocated resources in this context will normally mean the fee the advertiser pays for having his messages displayed.

In accordance with a third aspect of the invention, the messages are multimedia messages such as images, animated computer graphics and sound. In a preferred embodiment of this aspect, the text part of the multimedia message is sent through a text to speech processor residing either on the information server, on the users computer or on a separate computer connected to the network, before being presented to the user. The text to speech converter will convert the text to a string of symbols or other data units representing phonemes, diphones or some other representation of speech, and this string of symbols or data units will be inputted to a speech synthesizer in the users computer, and possibly also to a computer graphics program generating a “talking head”.

The characterizing features of the invention are defined in the independent claims. The dependent claims define particular additional features and preferred embodiments.

### DESCRIPTION OF THE DRAWINGS

The various advantages of the present invention will become apparent to those skilled in the art by reading the following specification and by reference to the drawings, where:

FIG. 1 shows a computer network on which the system according to the present invention is in operation,

FIG. 2 shows an example of a message displayed by a system according to the present invention,

FIG. 3 is a block diagram of an information tree illustration the organization of information in the system according to the present invention,

FIG. 4 shows a registration form for a user who wants to register with a system according to the present invention,

FIG. 5 shows a message presentation report generated by an information server that is part of a system according to the present invention,

FIG. 6 shows a computer animation that can be used for pressenting messages according to the present invention.

### DETAILED DESCRIPTION OF THE INVENTION

The present invention is a system for interactive distribution of information on a computer network such as the Internet. These messages can in principle be of any nature, commercial or non-commercial. In the following description, however, the information will be referred to as advertisements or messages and the information providers will be referred to as advertisers. This is for convenience only, and must not be interpreted as limiting to the invention, which can also cover information from non-profit organizations, political campaign information, entertainment or any other kind of information from any kind of information provider. Further, the system will be described as running on one information server, but it will be obvious to one skilled in the art that different functions of the system according to the invention can run on several computers connected to the computer network.

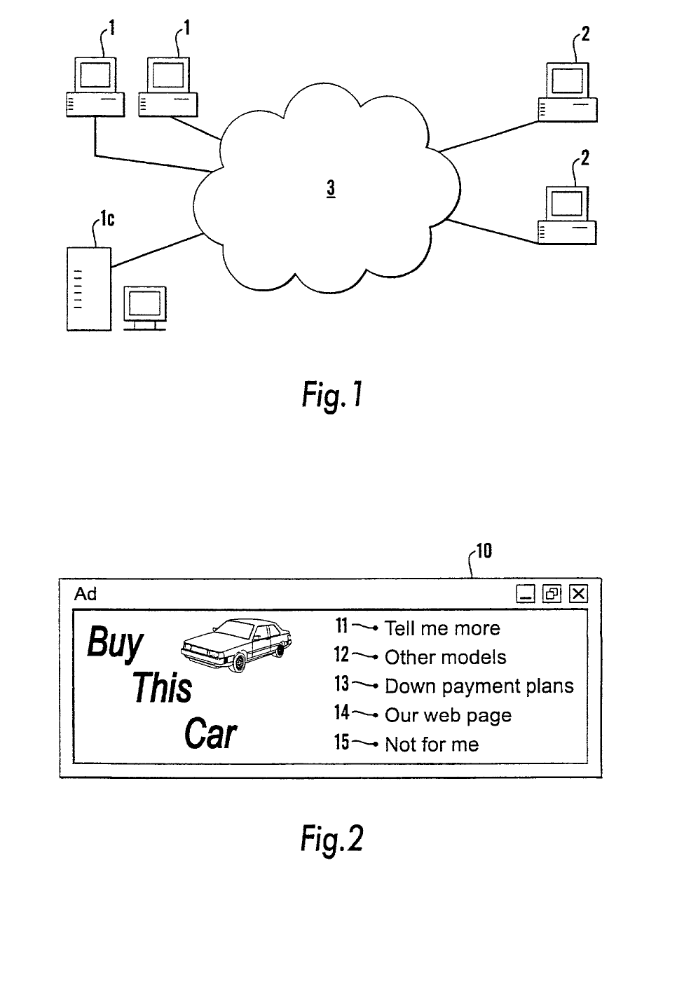

Referring now to FIG. 1, the present invention allows any number of advertisers 1 to present their messages to a number of users 2 that are connected to a computer network 3. The messages are preferably stored as information trees on an information server 4 that delivers the messages to the users' computers 2. The particular message selected for presentation to a particular user may be chosen based on the user's profile as stored in a user database and referenced to by a user ID, as well as the preferred demographic group targeted by the advertiser, but it may also simply be linked to other information available on the network, such as Web pages, entertainment such as audio or video and the like. When a user 2 connects to the network 3 and requests information, the message from the information server 4 will be transferred to the users' computer 2. If the message is linked to other information content on the network, such as a Web page, it is possible simply to embed the information in the information sought by the user and display it in the form of e.g. a banner on the Web page displayed by the users browser. When the message is detached from the information sought by the user, however, the message will preferably be presented in a separate window (10, FIG. 2) on the display of the users computer 2.

Reffering to FIG. 2, in addition to the actual information content of the message, the user will be presented with one or more choices for feed back to the system. These choices preferably include a request for additional information 11, 12, 13, a link to a web page 14, as well as an indication that the information content is of no interest to the user 15. When the user selects one of these options, a message will be sent back to the information server. If the user's response is a link to a web page, the users browser will retrieve this web page from the network, while a message is sent to the information server indicating the users choice. If the selected option is that the user is not interested in this information, this information is transmitted to the information server. In either of these cases the server records the users response and preferably a new message is selected and sent to the user. On the other hand, if the response is a request for further information, this is recorded by the server and the requested information is transmitted to the user. In principle, there are no limits to the number of options given to a user, but normally the user will be presented with one or just a few different requests for additional information. E.g. in the case where the message is an advertisement for a car, the user will be given the options to ask for more information about the particular model, about what other models are available, about down payment plans, etc. as well as an option to go to a particular web page or to indicate that he is not interested.

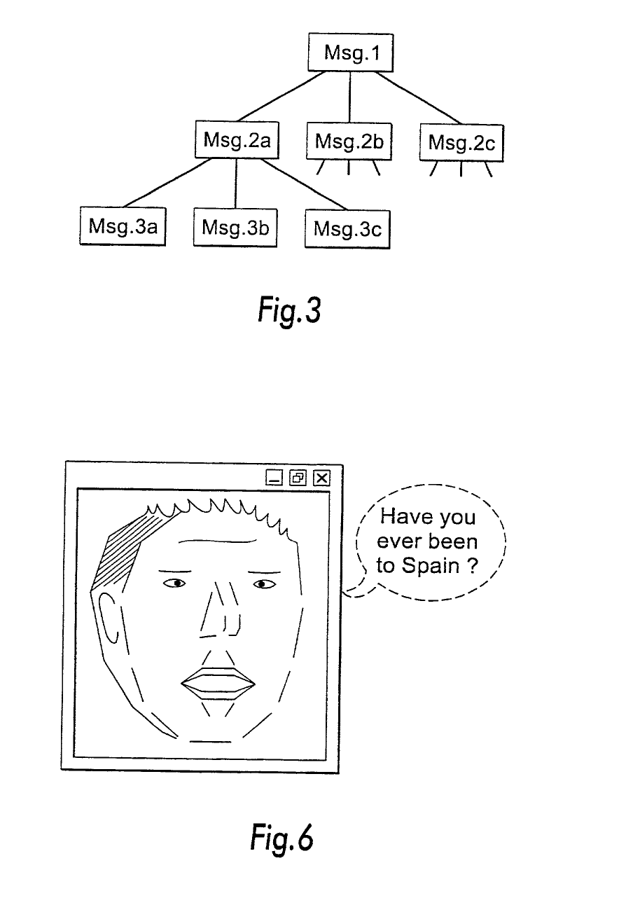

Referring to FIG. 3, in the information server 4 the messages are arranged in an information tree. This means that preferably each first message Msg.1 stored on the information server is linked to one or more additional messages Msg.2a, Msg.2b, Msg.2c, and that these additional messages again are linked to additional messages Msg.3a, Msg.3b, Msg.3d, and so on until the end of the tree is reached in each case. The user is given the opportunity to access the additional messages through the feed back choices presented when messages are displayed on the user's computer 2. Preferably the information server 4 records each time a particular message is displayed and generates reports based on these statistics.

As an alternative to the above, the entire information tree defined by an advertiser can be transmitted at once, only to be displayed by the user's computer in accordance with the choices made by the user. In this case, the program that handles the presentation at the user's computer 2, the client, records the choices made by the user and sends this recorded information back to the information server 4. This information can be transmitted either every time the user makes a choice or after the user has made a choice that indicates that he is abandoning this particular information tree.

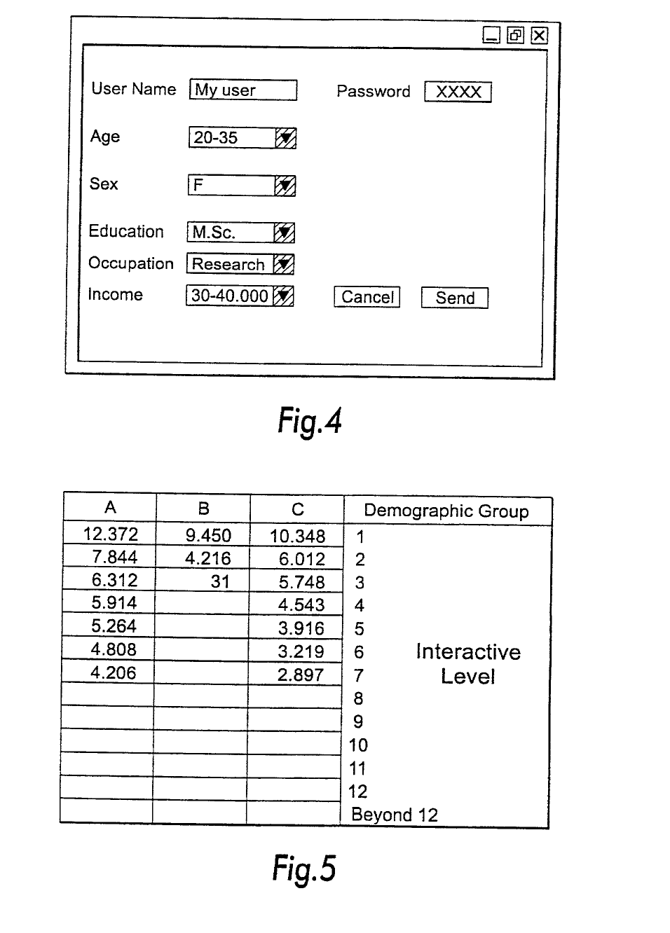

In order for advertisers to target users efficiently, the information server will preferably include a database containing user profiles. This database can in principle be generated in a number of ways, but in a preferred embodiment of the invention, first time users receive a user name when they register and enter their profile into the database. FIG. 4 shows an example of what such a registration form might look like. The profile will typically consist of such information as age, gender, educational level, occupation, yearly income, interests and hobbies, favorite magazines etc. The user profile will normally not include the users name in order to protect the privacy of the user. When the user connects to the network he or she will be identified by a user ID that is transferred to the information server 4 when the user logs on to the system with a user name, by way of a “cookie” stored on the user's computer or by other means that will associate the user with a stored user profile without revealing the users identity. One way of accomplishing this is for the user's browser or a plug-in to the user's browser to establish the connection with the information server 4 in the background when the user connects to the network 3. In this manner the browser, preferably in a separate window or as a pop-up, will retrieve messages or information trees from the information server 4 without interfering unduly with the user's activities on the network.

Advertisers will now be able to specify what user groups they want to target with their advertisements. A particular message or information tree can be so defined as to only be displayed to, say, men between 18 and 35 years old with an annual income between USD 20,000 and 30,000 and with a special interest in cars. Another message might on the other hand be so defined as to be displayed to several different demographic groups, such as men between 18 and 35 years old (group A), men between 35 and 50 years old (group B) and women between 18 and 50 years old (group C). Whenever either of these criteria are fulfilled, the corresponding message might be selected for display.

In a preferred embodiment of the invention, the advertisers have on-line access to the information server where they can review the presentation statistics generated as well as change the content of their messages or the targeted user profiles. Referring to the example above where an advertiser has decided that he wants to target the groups A, B and C. By accessing the information server 3 the advertiser will be able to bring up on the display of his computer 1 a presentation of the report generated by the information server 3. An example of such a report is shown in FIG. 5a. Such a report might e.g. show the advertiser that group B, men between 35 and 50 years old, hardly ever reach beyond level 2 in the information tree. In other words, when users whose user profile satisfies criteria B are exposed to the first level message, they either indicate no interest at that point or they proceed to one of the level two messages only to indicate their lack of interest at that point. In contrast, in this example users satisfying criteria A or criteria C tend to proceed much further in the message tree, e.g. 34% of group A and 28% of group C proceeds beyond level 6. In this case, the advertiser might decide that he will no longer pay for having his messages displayed to users belonging to group B since they do not seem to be effective, and consequently he removes group B from his list of targeted groups. As a result of this change, the advertiser might also choose to redesign his messages. If some of the options or messages were in whole or part designed primarily with the now removed group B in mind, the advertiser might choose to remove this content and possibly replace it with alternative content. This gives the advertiser a unique way of reacting immediately to user response to his advertising and change his marketing strategy in real time.

The price for delivery of messages may be fixed, or based on the size of the presentation. In other words, the advertiser pays the owner or operator of the system according to the present invention a certain amount for each delivery of a message. But according to a preferred embodiment of the invention, the price for the first presentation, i.e. the price for having the first message in the information tree transferred, is variable. One alternative is to let the advertisers set the price themselves, above a certain minimum. The messages will then be queued according to this pricing, with advertisers who bid the highest having their messages presented first. In this way, a user whose user profile satisfies the criteria of more than one advertisement or information tree will first be exposed to the first message in the information tree of the advertiser that has made the highest bid in order to reach this user. The bid need not be the same for the different groups specified by the advertiser. Referring back to the previous example this means that the advertiser need not bid the same amount for messages delivered to group A, group B, and group C. Only after the user has indicated that he is no longer interested in receiving messages from this information tree or he has reached the end of the information tree will he receive messages from the next advertiser. Instead of ordering the advertisements in a queue the different information trees can be given different likelihood of being selected based on how high they bid. In the case where a large number of advertisers compete for the attention of the users who might not be on-line for a very long time this might be preferable, because it will make the system interesting also to advertisers that do not have the resources to place their messages at the head of the queue. It will be a matter of choice for the operator of the system to determine what pricing strategy he finds most beneficial.

According to a preferred embodiment of the invention, the user, when presented with the different response alternatives, will be given the choice of being connected to a live operator. If this alternative is chosen, the user will be connected, directly or through the information server, to an operator representing the advertiser. This connection can be in the form of IRC (Internet Relay Chat), or through some other communication means over the network, such as voice or video conference.

Referring now to FIG. 6, a preferred embodiment involving computer graphics and/or text to speech technology will be described. According to this embodiment, the text part of the messages in the information tree are run through a text to speech converter that converts the text to a string of phonemes, diphones or some other representation of speech, and this string is forwarded to a speech synthesizer running on the user's computer 2. Preferably this input is also forwarded to a graphics animation program that presents an animated “talking head”. In this way, in addition to be presented with any graphics or audio information that is part of the message or messages from the advertiser, the text part of the message will be spoken by an animated figure in a particular window on the user's display. In the case where the user has chosen to connect to a live operator through a chat connection, the talking head will speak whatever the operator types in at his computer 1. The text to speech converter can be running on the user's computer 2, on the information server 4 or on any other computer connected to the network 3. In the latter case, the text part of the message is routed by way of the computer running the text to speech converter and then redirected to the user's computer 2.

As already mentioned, the connection from the user's computer to the information server 4 over the network 3 can be handled in the background of whatever session the user is involved in on the network 3 by the user's browser or a plug-in to the user's browser. In a preferred embodiment this browser or plug-in provides additional functionality for communication with the information server 4. This additional functionality can include access to statistics generated by the information server 4, the ability to upload, to the information server 4, information trees and any additional files (graphics, audio, video etc.) that are to be appended to the messages, as well as the ability to enter and change bids regarding how much one is willing to pay for the display of a message. In this way any user 2 who is connected to the network and who is authorized to upload information to the information server 4 can also act as an advertiser 1. Preferably a chat client is included in this software so that a chat connection between any two users of the system can be established if one of the users has included such an alternative as one of the responses to any of the messages in the information tree that constitutes his advertisement.

The present invention has been described by way of an example including a number of advertisers, a number of users and one information server. It will be obvious to one of ordinary skill, however, that a number of variations are possible. The different functions of the information server could for instance be run on different computers, such as one for the database containing the information in the advertisments, one being the communications server connected to the computer network and one handling the statistics and the price information regarding displays of messages. It would furthermore be possible to realize a system wherein the information service provider and the advertiser, or information provider, was one and the same. In other words, it would be possible for the operator who is running the information server to deny access to any external advertisers and only present his own messages, or possibly only present messages he has installed on the information server himself on behalf of other advertisers. It is also possible to combine the presentation of advertisements with other presentations such as news and entertainment.

1. A method for interactive distribution and presentation of information and for measuring information exposure, comprising:
organizing each of a plurality of message sets into a multi-level information tree structure, some messages in said multi-level information tree being arranged for sequential presentation and some messages in said multi-level information tree being arranged for alternative presentation, and storing each of said plurality of message sets on at least one computer that is connected to a computer network;
assigning selection criteria to each message set;
selecting, based on the selection criteria, one of the message sets for presentation to a user connected to the network and presenting a message of a first level in the multi-level information tree corresponding to the selected message set to said user along with a plurality of response choices;
receiving a selected response from the user;
selectively and iteratively presenting messages of subsequent levels in the multi-level information tree corresponding to the selected message set to said user along with subsequent response choices based on user response to previously presented response choices;
monitoring a level of said multi-level tree structure that said user reached during said step of selecting and iteratively presenting messages; and
generating statistics for each selected message set, said statistics indicating for each of a plurality of levels in the corresponding information tree the likelihood that users in a given demographic group are presented with a message in that level.

2. The method according to claim 1, wherein the message set is selected by referring to said information tree or a group of information trees to which said information tree belongs and based on some information the user retrieves from a computer connected to the computer network.

3. The method according to claim 1, wherein the step of selecting a message set for presentation to a user includes:
receiving from the user's computer a user ID that refers to a user profile in a user profile database,
comparing the user profile with selection criteria associated with the message sets, and
selecting a message set with criteria that are fulfilled by the user profile.

4. The method according to claim 1, wherein the step of selecting a message set for presentation to a user includes:
assigning priorities to the message sets; and
selecting the message set with the highest priority of all the message sets that are eligible for selection.

5. The method according to claim 1, wherein messages in the selected message set are embedded in information the user accesses from a computer on the computer network.

6. The method according to 1, wherein messages are transferred to the user's computer in a form that will cause such messages to be presented separate from any other information presented to the user, such as in a separate window, in a pop-up window on the display of the user's computer, or as audio, or as a combination thereof.

7. The method according to claim 1, wherein messages in the message sets are multimedia messages.

8. The method according to claim 1, wherein any text portions of the messages are run through a text to speech converter and a speech synthesizer in order to be presented to the user as audible speech.

9. The method according to claim 8, wherein the output of the text to speech converter or the speech synthesizer is forwarded to computer animation means on the user's computer in order to generate the animated image of a talking head.

10. A method for interactive distribution and presentation of information and for generating revenue from such interactive distribution and presentation of information, said method comprising:
organizing each of a plurality of message sets into a multi-level information tree structure, some messages in said multi-level information tree being arranged for sequential presentation and some messages in said multi-level information tree being arranged for alternative presentation, and storing each of said plurality of message sets on at least one computer that is connected to a computer network, the determination of which messages are included in which levels of said information tree being based on a fee arrangement that charges higher fees for messages in lower levels of said multi-level information tree relative to messages in higher levels of said multi-level information tree;
assigning selection criteria to each message set;
selecting, based on the selection criteria, one of the message sets for presentation to a user connected to the network and presenting a message of a first level in the multi-level information tree corresponding to the selected message set to said user along with a plurality of response choices;
receiving a selected response from the user;
selectively and iteratively presenting messages of subsequent levels in the multi-level information tree corresponding to the selected message set to said user along with subsequent response choices based on user response to previously presented response choices;
monitoring a level of said multi-level tree structure that said user reached during said step of selecting and iteratively presenting messages; and
generating statistics for each selected message set, said statistics indicating for each of a plurality of levels in the information tree corresponding to the selected message set the likelihood that users in a given demographic group are presented with a message in that level.

11. A method for interactive distribution and presentation of information and for generating revenue from such interactive distribution and presentation of information, comprising:
organizing each of a plurality of message sets into a multi-level information tree structure, some messages in said multi-level information tree being arranged for sequential presentation and some messages in said multi-level information tree being arranged for alternative presentation, and storing each of said plurality of message sets on at least one computer that is connected to a computer network;
assigning selection criteria to each message set;
selecting, based on the selection criteria, one of the message sets for presentation to a user connected to the network and presenting a message of a first level in the multi-level information tree corresponding to the selected message set to said user along with a plurality of response choices, the likelihood of selection for a given message set being a function of a priority fee arrangement for presenting said given message set;
receiving a selected response from the user,
selectively and iteratively presenting messages of subsequent levels in the multi-level information tree corresponding to the selected message set to said user along with subsequent response choices based on user response to previously presented response choices;
monitoring a level of said multi-level tree structure that said user reached during said step of selecting and iteratively presenting messages; and
generating statistics for each selected message set, said statistics indicating for each of a plurality of levels in the information tree corresponding to the selected message set the likelihood that users in a given demographic group are presented with a message in that level.

12. A method for targeting interactive distribution and presentation of information, comprising:
organizing each of a plurality of message sets into a multi-level information tree structure, some messages in said multi-level information tree being arranged for sequential presentation and some messages in said multi-level information tree being arranged for alternative presentation, and storing each of said plurality of message sets on at least one computer that is connected to a computer network;
assigning selection criteria to each message set;
selecting, based on the selection criteria, one of the message sets for presentation to a user connected to the network and presenting a message of a first level in the multi-level information tree corresponding to the selected message set to said user along with a plurality of response choices,
receiving a selected response from the user,
selectively and iteratively presenting messages of subsequent levels in the multi-level information tree corresponding to the selected message set to said user along with subsequent response choices based on user response to previously presented response choices;
monitoring a level of said multi-level tree structure that said user reached during said step of selecting and iteratively presenting messages;
generating statistics for each selected message set, said statistics indicating for each of a plurality of levels in the information tree corresponding to the selected message set the likelihood that users in a given demographic group are presented with a message in that level; and
updating said selection criteria based on the generated statistics.

13. A system for interactive distribution and presentation of information and for measuring information exposure, comprising:
at least one computer connected to a computer network, said at least one computer including storage means in which information is stored in the form of a plurality of message sets, each of said plurality of messages sets being organized as a multi-level information tree structure, some messages in said multi-level information tree being arranged for sequential presentation and some messages in said multi-level information tree being arranged for alternative presentation, each message set being assigned selection criteria;
means for selecting, based on the selection criteria, one of the stored message sets for presentation to a user connected to the network;
means for presenting a message of a first level in the multi-level information tree corresponding to the selected message set to said user along with a plurality of response choices, receiving a selected response from the user, and selectively and iteratively presenting messages of subsequent levels in the multi-level information tree corresponding to the selected message set to said user along with subsequent response choices based on user response to previously presented response choices;
means for monitoring a level of said multi-level tree structure that said user has reached during selective and iterative presentation of messages; and
means for generating statistics for each selected message set, said statistics indicating for each of a plurality of levels in the corresponding information tree the likelihood that users in a given demographic group are presented with a message in that level.

14. The system according to claim 13, wherein
said at least one computer comprises means for receiving a user ID from a user connected to the network and means for storing a user database containing user profiles, and
said means for selecting one of the message sets includes means for making this selection based on a comparison of selection criteria associated with the stored message sets and a user profile in said user profile database referred to by the received user ID.

15. The system according to claim 13, wherein
said at least one computer further includes means for assigning priorities to message sets stored on the storage means, and
said means for selecting one of the message sets includes means for making this selection based on a comparison of said priorities.

16. The system according to claim 15, wherein said means for generating statistics includes means for registering how many times a particular message set or particular part of a message set is presented and means for generating and presenting statistics in real time, based on such registration.

17. The system according to claim 13, wherein
said at least one computer comprises means for converting data representing text to data representing sounds of speech, and
said means for presenting is arranged to transmit any text part of a message that is part of the selected message set to said text to speech converter, said text to speech converter being arranged to forward the converted data representing sounds of speech.

18. A system for interactive distribution and presentation of information and for generating revenue for such interactive distribution and presentation, comprising:
at least one computer connected to a computer network, said at least one computer including storage means in which information is stored in the form of a plurality of message sets, each of said plurality of messages sets being organized as a multi-level information tree structure, some messages in said multi-level information tree being arranged for sequential presentation and some messages in said multi-level information tree being arranged for alternative presentation, the determination of which messages are included in which levels of said information tree being based on a fee arrangement that charges higher fees for messages in lower levels of said multi-level information tree relative to messages in higher levels of said multi-level information tree, each message set being assigned selection criteria;
means for selecting, based on the selection criteria, one of the stored message sets for presentation to a user connected to the network;
means for presenting a message of a first level in the multi-level information tree corresponding to the selected message set to said user along with a plurality of response choices, receiving a selected response from the user, and selectively and iteratively presenting messages of subsequent levels in the multi-level information tree corresponding to the selected message set to said user along with subsequent response choices based on user response to previously presented response choices;
means for monitoring a level of said multi-level tree structure that said user has reached during selective and iterative presentation of messages; and
means for generating statistics for each selected message set, said statistics indicating for each of a plurality of levels in the corresponding information tree the likelihood that users in a given demographic group are presented with a message in that level.

19. A system for interactive distribution and presentation of information and for generating revenue for such interactive distribution and presentation of information, comprising:
at least one computer connected to a computer network, said at least one computer including storage means in which information is stored in the form of a plurality of message sets, each of said plurality of messages sets being organized as a multi-level information tree structure, some messages in said multi-level information tree being arranged for sequential presentation and some messages in said multi-level information tree being arranged for alternative presentation, each message set being assigned selection criteria;
means for selecting, based on the selection criteria, one of the stored message sets for presentation to a user connected to the network, the likelihood of selection for a given message set being a function of a priority fee arrangement for presenting said message set;
means for presenting a message of a first level in the multi-level information tree corresponding to the selected message set to said user along with a plurality of response choices, receiving a selected response from the user, and selectively and iteratively presenting messages of subsequent levels in the multi-level information tree corresponding to the selected message set to said user along with subsequent response choices based on user response to previously presented response choices;
means for monitoring a level of said multi-level tree structure that said user has reached during selective and iterative presentation of messages; and
means for generating statistics for each selected message set, said statistics indicating for each of a plurality of levels in the corresponding information tree the likelihood that users in a given demographic group are presented with a message in that level.

20. A system for targeting interactive distribution and presentation of information, comprising:
at least one computer connected to a computer network, said at least one computer including storage means in which information is stored in the form of a plurality of message sets, each of said plurality of messages sets being organized as a multi-level information tree structure, some messages in said multi-level information tree being arranged for sequential presentation and some messages in said multi-level information tree being arranged for alternative presentation, each message set being assigned selection criteria;
means for selecting, based on the selection criteria, one of the stored message sets for presentation to a user connected to the network;
means for presenting a message of a first level in the multi-level information tree corresponding to the selected message set to said user along with a plurality of response choices, receiving a selected response from the user, and selectively and iteratively presenting messages of subsequent levels in the multi-level information tree corresponding to the selected message set to said user along with subsequent response choices based on user response to previously presented response choices;
means for monitoring a level of said multi-level tree structure that said user has reached during selective and iterative presentation of messages;
means for generating statistics for each selected message set, said statistics indicating for each of a plurality of levels in the corresponding information tree the likelihood that users in a given demographic group are presented with a message in that level;
means for updating said selection criteria based on said generated statistics.
